(19) United States
(12) Patent Application Publication
(10) Pub. No.: US 2026/0167060 A1
(43) Pub. Date: Jun. 18, 2026

(54) SYSTEMS AND METHODS FOR PERFORMING SMART SEAT HEATER CONTROL

(71) Applicants: Hyundai Motor Company, Seoul (KR); Kia Corporation, Seoul (KR)

(72) Inventor: Scott Ziolek, Superior Township, MI (US)

(21) Appl. No.: 18/982,719

(22) Filed: Dec. 16, 2024

(51) Int. Cl. B60N 2/00; B60N 2/56

(52) U.S. Cl. CPC B60N 2/0022; B60N 2/0035; B60N 2/5685

(57) ABSTRACT

A smart automotive seat and methods of use are provided. The smart automotive seat may comprise a heating component, a temperature sensor configured to measure one or more temperature inputs, and an electronic control unit, comprising a processor and a memory. The memory is configured to store instructions that, when executed by the processor, are configured to cause the processor to read and store, in the memory, the one or more temperature inputs from the temperature sensor, read and store, in the memory, one or more time inputs, calculate an Accumulated Exposure Area (AEA) based on the one or more temperature inputs and the one or more time inputs, determine whether the AEA is greater than a Target Temperature Exposure Area Limit (TEAL), and, when the AEA is greater than the TEAL, reduce the current heat level of the heating component.

### BACKGROUND

### Technical Field

Embodiments of the present disclosure relate to systems and methods for performing smart seat heater operation based on accumulated exposure area defined as a function of the times and temperatures exceeding a critical temperature threshold.

### BACKGROUND

Many vehicles comprise seat heaters configured to heat one or more seats of the vehicle. Seat heater temperature may be controlled based on ambient interior conditions, with the seat never reaching high contact temperatures.

Heated seats complement existing HVAC systems to provide occupant thermal comfort, heated seat surfaces encompass large a contact area with the body, and heated seats heat up faster than the interior ambient space of the vehicle using the HVAC system, providing quicker thermal comfort. However, contact with the heated seat surfaces increases the risk of thermal injuries. A target temperature magnitude, contact duration, and pre-target accumulated heat energy impact the risk of thermal injuries.

An automatic step down feature may be used to reduce heat after a set time limit (e.g., high heat to medium heat after 30 minutes) regardless of the actual seat temperature. This time limit is fixed regardless of increased exposure on warm days and decreased exposure on colder days.

### SUMMARY

According to an object of the present disclosure, a smart automotive seat is provided. The smart automotive seat may comprise a heating component, a temperature sensor configured to measure one or more temperature inputs, and an electronic control unit, comprising a processor and a memory. The memory may be configured to store instructions that, when executed by the processor, are configured to cause the processor to read and store, in the memory, the one or more temperature inputs from the temperature sensor, read and store, in the memory, one or more time inputs, and calculate an Accumulated Exposure Area (AEA) based on the one or more temperature inputs and the one or more time inputs. The AEA is an accumulated area under a temperature time curve and above a Critical Temperature Threshold Value (CTTV), and the CTTV is a predetermined temperature value representing little to no risk of thermal injury. The instructions, when executed by the processor, may be configured to cause the processor to determine whether the AEA is greater than a Target Temperature Exposure Area Limit (TEAL), and, when the AEA is greater than the TEAL, reduce the current heat level of the heating component. The TEAL is a predetermined exposure area limit for a current heat level of the heating component.

According to an exemplary embodiment, the instructions, when executed by the processor, may be configured to cause the processor to calculate a current AEA.

According to an exemplary embodiment, calculating the current AEA may comprise calculating a current seat Heater Sensor Temperature (HST), determining whether the HST is greater than the CTTV, when the HST is greater than the CTTV, calculating a Sensor Time Interval (STI) by determining a time interval since a last temperature sensor reading, calculating a Critical Sensor Temperature (CST) by determining a temperature difference between the HST and the CTTV, and calculating a Sensor Exposure Area (SEA) by determining a product of the CST and the STI.

According to an exemplary embodiment, the current AEA equals a sum of the SEA and a previous AEA.

According to an exemplary embodiment, the instructions, when executed by the processor, may be configured to cause the processor to determine whether a user has changed the current heat level of the heating component.

According to an exemplary embodiment, the instructions, when executed by the processor, may be configured to cause the processor to, after reducing the current heat level of the heating component, determine whether the heating component is off.

According to an exemplary embodiment, the electronic control unit may comprise a computing device of a vehicle.

According to an object of the present disclosure, a system for performing smart seat heater operation is provided. The system may comprise a vehicle comprising one or more smart automotive seats. Each smart automotive seat may comprise a heating component, a temperature sensor configured to measure one or more temperature inputs, and an electronic control unit, comprising a processor and a memory. The memory may be configured to store instructions that, when executed by the processor, are configured to cause the processor to read and store, in the memory, the one or more temperature inputs from the temperature sensor, read and store, in the memory, one or more time inputs, and calculate an AEA based on the one or more temperature inputs and the one or more time inputs. The AEA is an accumulated area under a temperature time curve and above a CTTV, and the CTTV is a predetermined temperature value representing little to no risk of thermal injury. The instructions, when executed by the processor, may be configured to cause the processor to determine whether the AEA is greater than a TEAL, and, when the AEA is greater than the TEAL, reduce the current heat level of the heating component. The TEAL is a predetermined exposure area limit for a current heat level of the heating component.

According to an exemplary embodiment, the instructions, when executed by the processor, may be configured to cause the processor to calculate a current AEA.

According to an exemplary embodiment, calculating the current AEA may comprise calculating a current seat HST, determining whether the HST is greater than the CTTV, when the HST is greater than the CTTV, calculating an STI by determining a time interval since a last temperature sensor reading, calculating a CST by determining a temperature difference between the HST and the CTTV, and calculating an SEA by determining a product of the CST and the STI.

According to an exemplary embodiment, the current AEA equals a sum of the SEA and a previous AEA.

According to an exemplary embodiment, the instructions, when executed by the processor, may be configured to cause the processor to determine whether a user has changed the current heat level of the heating component.

According to an exemplary embodiment, the instructions, when executed by the processor, may be configured to cause the processor to, after reducing the current heat level of the heating component, determine whether the heating component is off.

According to an exemplary embodiment, the electronic control unit may comprise a computing device of the vehicle.

According to an object of the present disclosure, a method for performing smart seat heater operation is provided. The method may comprise measuring, using a temperature sensor of a smart automotive seat, one or more temperature inputs. The smart automotive seat may comprise a heating component, the temperature sensor, and an electronic control unit, comprising a processor and a memory. The method may comprise, using the electronic control unit, reading and storing, in the memory, the one or more temperature inputs from the temperature sensor, reading and storing, in the memory, one or more time inputs, and calculating an AEA based on the one or more temperature inputs and the one or more time inputs. The AEA is an accumulated area under a temperature time curve and above a CTTV, and the CTTV is a predetermined temperature value representing little to no risk of thermal injury. The method may comprise, using the electronic control unit, determining whether the AEA is greater than a TEAL, and, when the AEA is greater than the TEAL, reducing the current heat level of the heating component. The TEAL is a predetermined exposure area limit for a current heat level of the heating component.

According to an exemplary embodiment, wherein the method may comprise calculating a current AEA.

According to an exemplary embodiment, the calculating the current AEA may comprise calculating a current seat HST, determining whether the HST is greater than the CTTV, when the HST is greater than the CTTV, calculating an STI by determining a time interval since a last temperature sensor reading, calculating a CST by determining a temperature difference between the HST and the CTTV, and calculating an SEA by determining a product of the CST and the STI.

According to an exemplary embodiment, the current AEA equals a sum of the SEA and a previous AEA.

According to an exemplary embodiment, the method may comprise determining whether a user has changed the current heat level of the heating component.

According to an exemplary embodiment, the method may comprise, after reducing the current heat level of the heating component, determining whether the heating component is off.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 illustrates a vehicle configured to perform smart seat heater operation based on accumulated exposure area defined as a function of the times and temperatures exceeding a critical temperature threshold, according to an exemplary embodiment of the present disclosure.

FIG. 2 illustrates a smart automative seat, according to an exemplary embodiment of the present disclosure.

FIG. 3 illustrates a graphical representation of an accumulated exposure area, according to an exemplary embodiment of the present disclosure.

FIGS. 4A-4B illustrate a flowchart of a method for performing smart seat heater operation, according to an exemplary embodiment of the present disclosure.

FIG. 5 illustrates a graphical representation of an Accumulated Exposure Area (AEA), according to an exemplary embodiment of the present disclosure.

FIG. 6 illustrates an example architecture of a vehicle, according to an exemplary embodiment of the present disclosure.

FIG. 7 illustrates example elements of a computing device, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

According to exemplary embodiments, systems and methods for performing smart seat heater operation based on accumulated exposure area defined as a function of the times and temperatures exceeding a critical temperature threshold are provided.

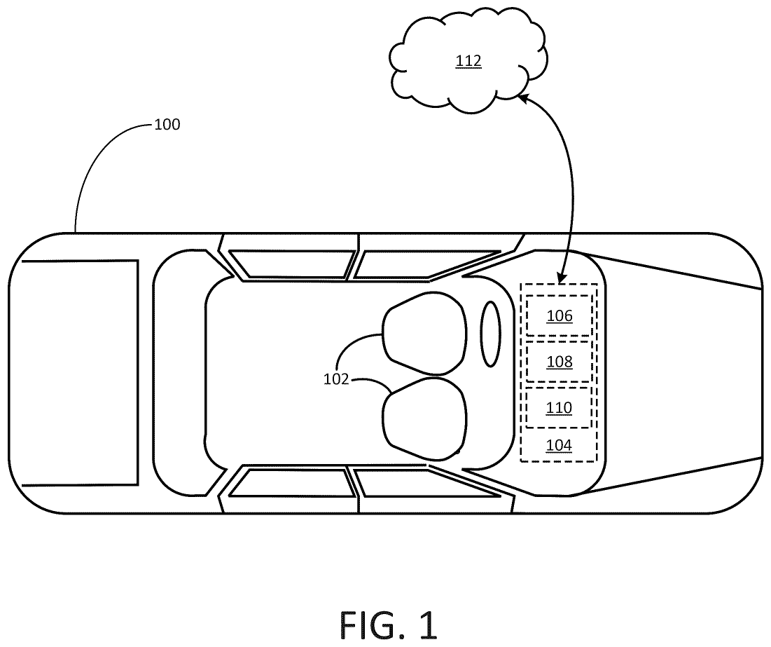

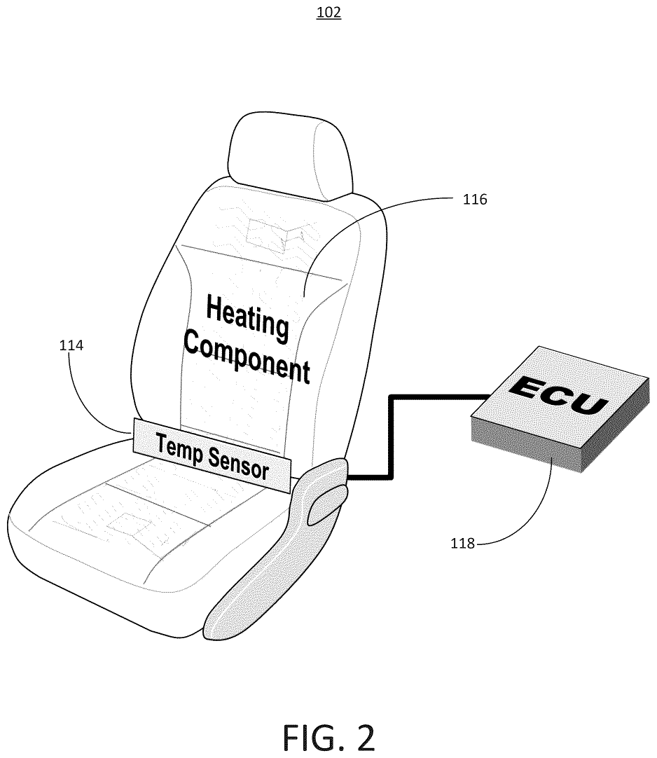

Referring now to FIGS. 1-2, a vehicle 100 (FIG. 1) configured to perform smart seat heater operation based on accumulated exposure area defined as a function of the times and temperatures exceeding a critical temperature threshold, and a smart automative seat 102 (FIG. 2) are illustratively depicted, in accordance with an exemplary embodiment of the present disclosure. According to an exemplary embodiment, the vehicle 100 may comprise an electric vehicle and/or other suitable vehicle.

Generally, when a seat heater is activated, the seat temperature is monitored until it reaches a Critical Temperature Threshold Value (CTTV). The CTTV is a predetermined temperature value representing little to no risk of thermal injury (e.g., typical body temperature). Seat temperatures that exceed a CTTV are combined into an Accumulated Exposure Area (AEA) and compared to a Target Temp Exposure Area Limit (TEAL).

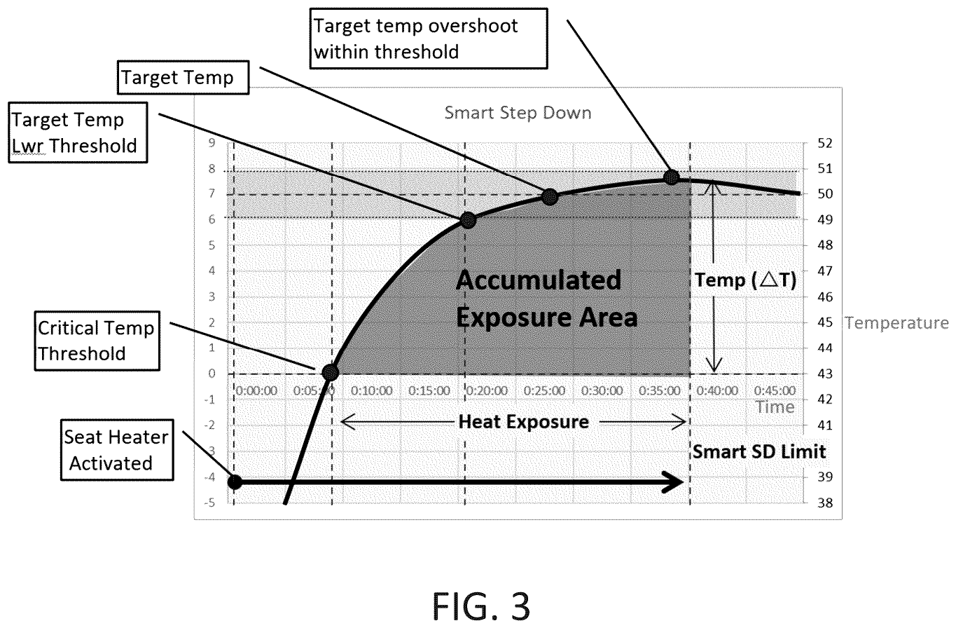

As shown in FIG. 3, the AEA is the accumulated area under the temperature time curve and above the critical temperature threshold. The TEAL is a predetermined exposure area limit for the selected seat heat setting. A Step Down (SD) limit is a step down time determined by the time where the AEA is equal to the TEAL.

When the AEA equals the TEAL, the seat heater setting may be reduced. An area-based exposure limit accounts for changes in heat accumulation and thermal performance over time, such as differences in the heat up rate, the heat outside of the target threshold, and fluctuations within the target threshold.

By controlling the seat heater based on actual seat temperatures experienced above a critical temperature, embodiments of the present disclosure reduce the risk of injury due to contact burns, reduce total energy used in warmer conditions, and provide a consistent user experience regardless of ambient conditions.

According to an exemplary embodiment, the vehicle 100 may comprise a computing device 104. The computing device 104 may comprise a processor 106, a memory 108, and/or a user interface 110 (e.g., a graphical user interface). The computing device 104 may be configured to send and/or receive commands/data/input/etc. via one or more external systems via wired and/or wireless connection (e.g., via the cloud 112).

According to an exemplary embodiment, the vehicle 100 may comprise one or more smart automative seats 102. According to an exemplary embodiment, the one or more smart automotive seats 102 may be in electronic communication with the one or more computing devices 104. The one or more computing devices 104 may be separate from the one or more smart automotive seats 102 and/or may be incorporated into the one or more smart automotive seats 102.

According to an exemplary embodiment, the smart automotive seat 102 may comprise one or more temperature sensors 114, heating components 116, and/or Electronic Control Units (ECUs) 118. According to an exemplary embodiment, the one or more ECUs 118 may each comprise a processor and/or a memory.

According to an exemplary embodiment, the one or more heating components 116 may comprise one or more wire elements and/or other materials and/or systems used to provide heat to the smart automotive seat 102. According to an exemplary embodiment, the one or more temperature sensors 114 may be configured to measure and/or check a current temperature of the smart automotive seat 102. According to an exemplary embodiment, the ECU 118 may be configured to read and/or store one or more temperature inputs from the one or more temperature sensors 114, read and/or store one or more time inputs, compute one or more math functions based on the one or more temperature inputs and one or more time inputs, compare one or more computed results to one or more present limits, and/or adjust power to the heating component 116. According to an exemplary embodiment, the one or more computing devices 104 may comprise the one or more ECUs 118 and/or may be coupled to the one or more ECUs 118.

The memory 108 may be configured to store programming instructions that, when executed by the processor 106, may be configured to cause the processor 106 to perform one or more tasks such as, e.g., activating one or more smart automative seats, activating one or more heating components 116, setting one or more preset limits, calculating an AEA, calculating a status of one or more smart automative seat 102 values, reducing a current smart automotive seat 102 heat level, determining whether one or more heating components 116 are on and/or off, and/or performing one or more other suitable tasks.

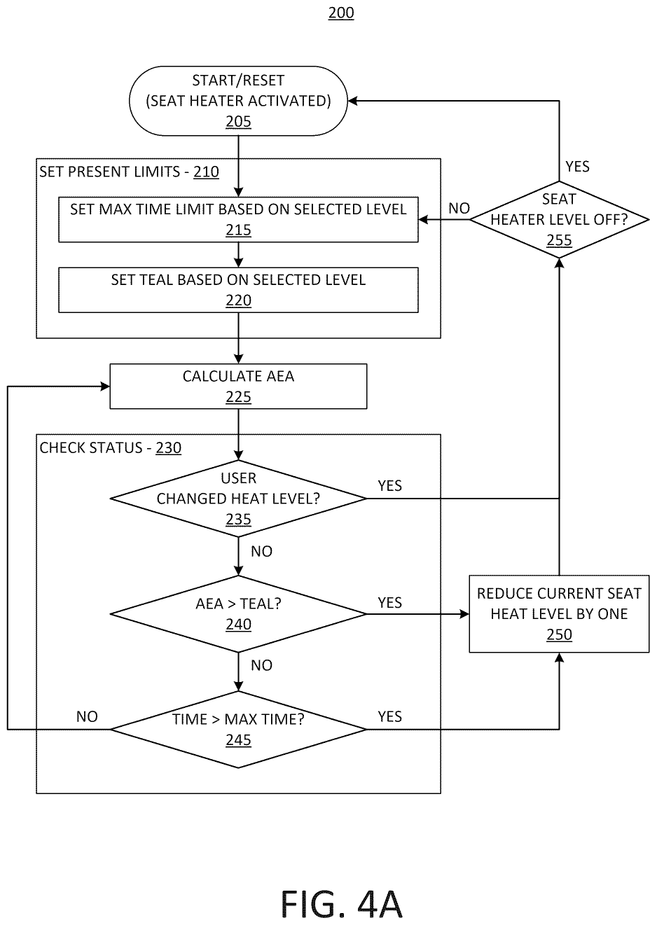

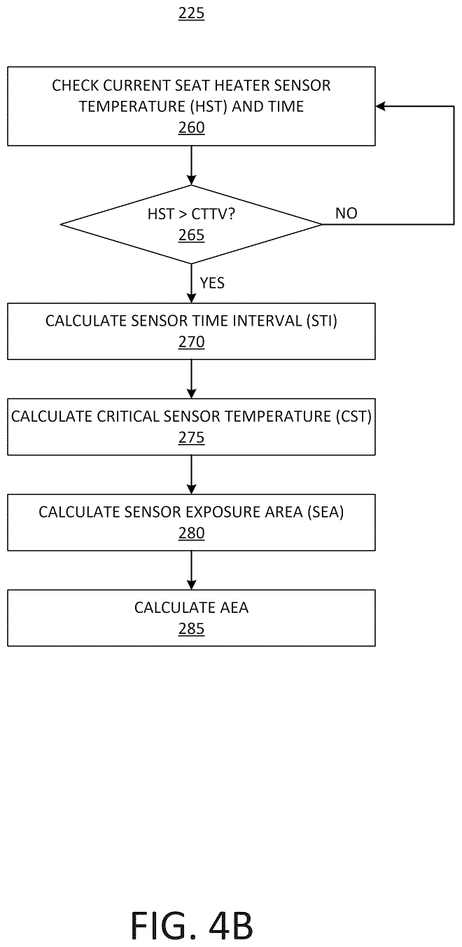

Referring now to FIGS. 4A-4B, a flowchart of a method 200 for performing smart seat heater operation is illustratively depicted, in accordance with an exemplary embodiment of the present disclosure.

At 205, the heating component of the smart automotive seat may be start or reset (e.g., activated). The heating component may be activated by a user and/or manually and/or automatically after a system event.

At 210, after heating component activation, one or more preset exposure limits/targets may be set. The one or more preset exposure limits/targets may comprise a maximum time limit, a TEAL, and/or other suitable exposure limits/targets. At 215, a maximum time limit may be set based on a selected heating component level. At 220, a TEAL may be set based on a selected heating component level.

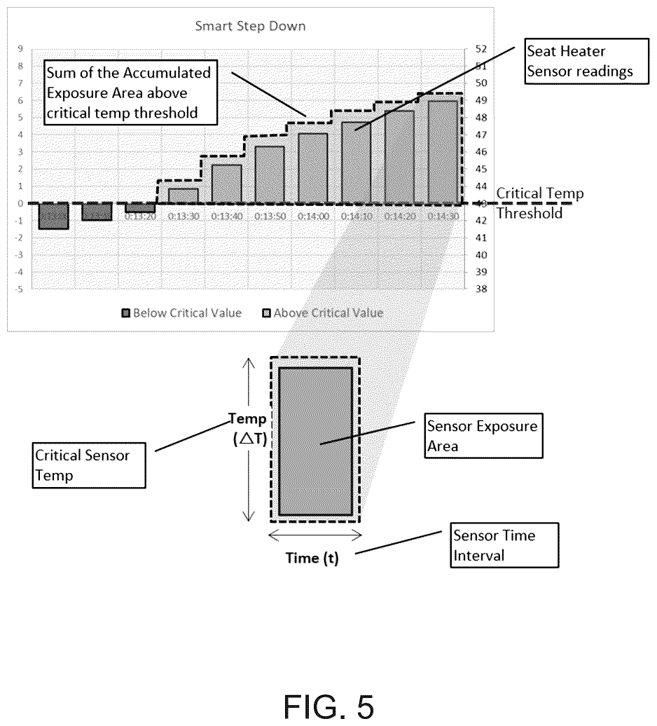

At 225, the current AEA may be calculated (as shown, in more detail, in, e.g., FIG. 4B). The AEA may be calculated as the sum of discrete exposure areas based on the interval between temperature measurements, as shown, e.g., in FIG. 5.

According to an exemplary embodiment, calculating the current AEA may comprise, at 260, checking a current seat Heater Sensor Temperature (HST). Checking the current seat HST may comprise recording the current heat sensor temperature and/or recording the time of the temperature sensor reading. The HST may be compared against the CTTV to determine, at 265, whether the HST is greater than the CTTV.

When the HST is not greater than the CTTV, then, at 260, the current HST and time may be checked. When the HST is greater than the CTTV, then, at 270, a Sensor Time Interval (STI) may be calculated by determining a time interval since a last temperature sensor reading.

At 275, a Critical Sensor Temperature (CST) may be calculated by determining a temperature difference between the HST and the CTTV (i.e., CST=HST−CTTV).

At 280, a Sensor Exposure Area (SEA) may be calculated by determining a product of the CST and the STI (i.e., SEA=CST*STI).

At 285, a current AEA may be calculated by determining a sum of the SEA and a previous AEA (i.e., (Current AEA)=(Previous AEA)+SEA).

At 230, a system status may be checked for changes in a selected heating level and to check is limits have been exceeded.

At 235, it may be determined whether a user have changes the selected heating level. When the user has changed the selected heating level, then, at 255, it may be determined whether the heating component of the smart automotive seat is off. When the heating component of the smart automotive seat is off, then, at 205, the heating component of the smart automotive seat may be start or reset. When the heating component of the smart automotive seat is not off, then, at 210, one or more preset exposure limits/targets may be set.

When the user has not changed the selected heating level, then, at 240, it may be determined whether the current AEA is greater than the TEAL. When the current AEA is greater than the TEAL, then, at 250, the current selected heating level may be reduced by one, and, at 255, it may be determined whether the heating component of the smart automotive seat is off. When the current AEA is not greater than the TEAL, then, at 245, it may be determined whether a current time is greater than the maximum time.

When the current time is greater than the maximum time, then, at 250, the current selected heating level may be reduced by one, and, at 255, it may be determined whether the heating component of the smart automotive seat is off. When the current time is not greater than the maximum time, then, at 225, the current AEA may be recalculated.

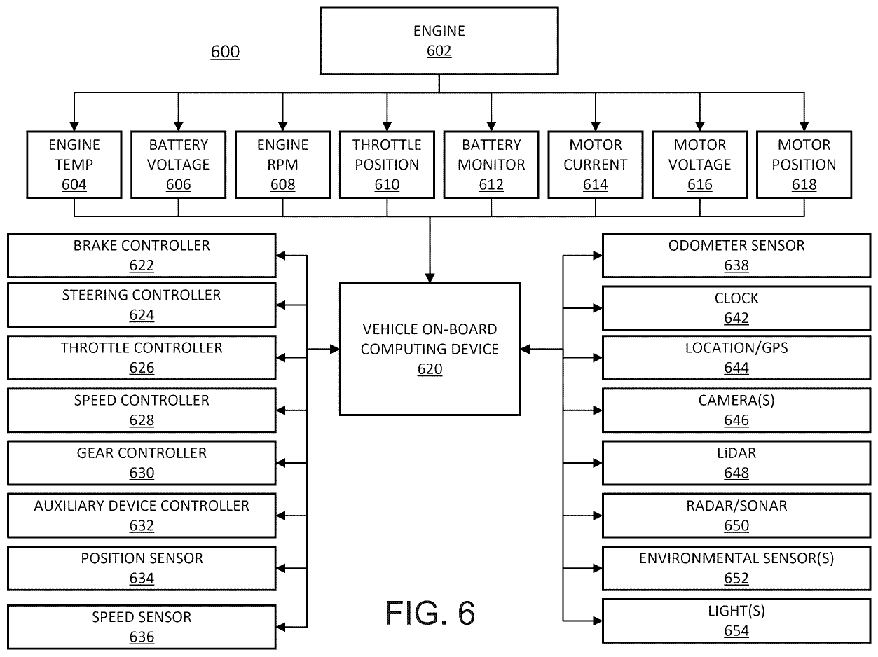

Referring now to FIG. 6, an example vehicle system architecture 600 for a vehicle is provided, in accordance with an exemplary embodiment of the present disclosure. The following discussion of vehicle system architecture 600 is sufficient for understanding one or more components of vehicle 100.

As shown in FIG. 6, the vehicle system architecture 600 may comprise an engine, motor or propulsive device 602 and various sensors 604-618 for measuring various parameters of the vehicle system architecture 600. In gas-powered or hybrid vehicles having a fuel-powered engine, the sensors 604-618 may comprise, for example, an engine temperature sensor 604, a battery voltage sensor 606, an engine Rotations Per Minute (RPM) sensor 608, and/or a throttle position sensor 610. If the vehicle is an electric or hybrid vehicle, then the vehicle may comprise an electric motor, and accordingly may comprise sensors such as a battery monitoring system 612 (to measure current, voltage and/or temperature of the battery), motor current 614 and voltage 616 sensors, and motor position sensors such as resolvers and encoders 618.

Operational parameter sensors that are common to both types of vehicles may comprise, for example: a position sensor 634 such as an accelerometer, gyroscope and/or inertial measurement unit; a speed sensor 636; and/or an odometer sensor 638. The vehicle system architecture 600 also may comprise a clock 642 that the system uses to determine vehicle time and/or date during operation. The clock 642 may be encoded into the vehicle on-board computing device 620, it may be a separate device, or multiple clocks may be available.

The vehicle system architecture 600 may comprise various sensors that operate to gather information about the environment in which the vehicle is traveling. These sensors may comprise, for example: a location sensor 644 (for example, a Global Positioning System (GPS) device); object detection sensors such as one or more cameras 646; a LiDAR sensor system 648; and/or a radar and/or a sonar system 650. The sensors may comprise environmental sensors 652 such as, e.g., a humidity sensor, a precipitation sensor, a light sensor, and/or ambient temperature sensor. The object detection sensors may be configured to enable the vehicle system architecture 600 to detect objects that are within a given distance range of the vehicle in any direction, while the environmental sensors 652 may be configured to collect data about environmental conditions within the vehicle's area of travel. According to an exemplary embodiment, the vehicle system architecture 600 may comprise one or more lights 654 (e.g., headlights, flood lights, flashlights, etc.).

During operations, information may be communicated from the sensors to an on-board computing device 620 (e.g., computing device 104, ecu 118). The on-board computing device 620 may be configured to analyze the data captured by the sensors and/or data received from data providers and may be configured to optionally control operations of the vehicle system architecture 600 based on results of the analysis. For example, the on-board computing device 620 may be configured to control: braking via a brake controller 622; direction via a steering controller 624; speed and acceleration via a throttle controller 626 (in a gas-powered vehicle) or a motor speed controller 628 (such as a current level controller in an electric vehicle); a differential gear controller 630 (in vehicles with transmissions); and/or other controllers. The brake controller 622 may comprise a pedal effort sensor, pedal effort sensor, and/or simulator temperature sensor, as described herein.

Geographic location information may be communicated from the location sensor 644 to the on-board computing device 620, which may then access a map of the environment that corresponds to the location information to determine known fixed features of the environment such as streets, buildings, stop signs and/or stop/go signals. Captured images from the cameras 646 and/or object detection information captured from sensors such as LiDAR 648 may be communicated from those sensors to the on-board computing device 620. The object detection information and/or captured images may be processed by the on-board computing device 620 to detect objects in proximity to the vehicle. Any known or to be known technique for making an object detection based on sensor data and/or captured images may be used in the embodiments disclosed in this document.

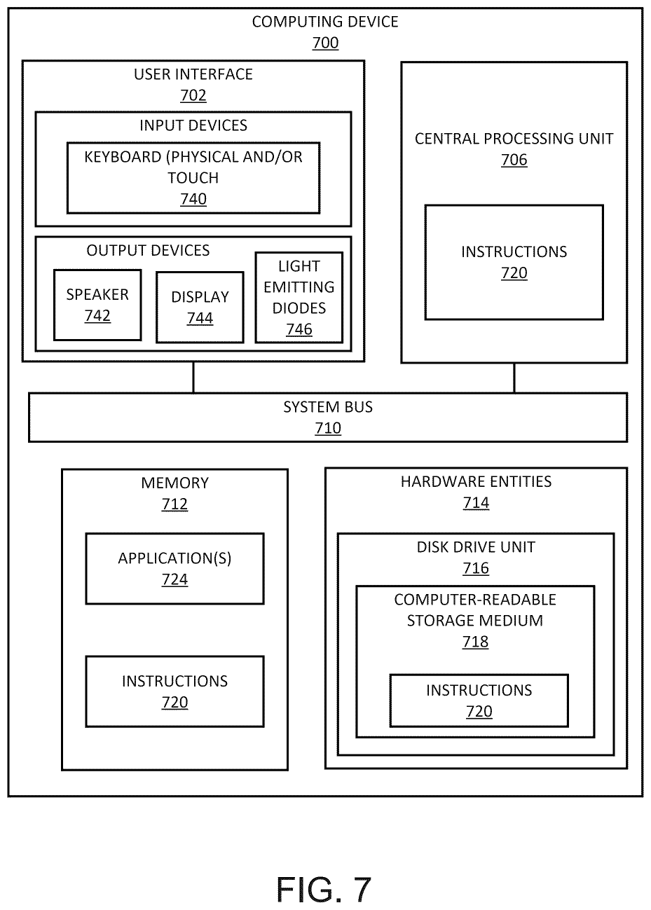

Referring now to FIG. 7, an illustration of an example architecture for a computing device 700 is provided. According to an exemplary embodiment, one or more functions of the present disclosure may be implemented by a computing device such as, e.g., computing device 700 or a computing device similar to computing device 700. Computing device 700 may be a quantum computer, a classical computer, and/or have one or more components configured to perform one or more quantum and/or classical computing functions. Computing device 104, ECU 118, and/or computing device 620 may be an example of computing device 700 and/or may comprise one or more components of computing device 700.

The hardware architecture of FIG. 7 represents one example implementation of a representative computing device configured to implement at least a portion of the systems/devices (e.g., vehicle 100 and automotive smart seat 102) and method(s)/control logic(s) (e.g., method 200) described herein.

Some or all components of the computing device 700 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 7, the computing device 700 may comprise a user interface 702 (e.g., a graphical user interface), a Central Processing Unit (“CPU”) 706, a system bus 710, a memory 712 connected to and accessible by other portions of computing device 700 through system bus 710, and hardware entities 714 connected to system bus 710. The user interface may comprise input devices and output devices, which may be configured to facilitate user-software interactions for controlling operations of the computing device 700. The input devices may comprise, but are not limited to, a physical and/or touch keyboard 740. The input devices may be connected to the computing device 700 via a wired or wireless connection (e.g., a Bluetooth® connection). The output devices may comprise, but are not limited to, a speaker 742, a display 744, and/or light emitting diodes 746.

At least some of the hardware entities 714 may be configured to perform actions involving access to and use of memory 712, which may be a Random Access Memory (RAM), a disk driver and/or a Compact Disc Read Only Memory (CD-ROM), among other suitable memory types. Hardware entities 714 may comprise a disk drive unit 716 comprising a computer-readable storage medium 718 on which may be stored one or more sets of instructions 720 (e.g., programming instructions such as, but not limited to, software code) configured to implement one or more of the methodologies, procedures, or functions described herein. The instructions 720 may also reside, completely or at least partially, within the memory 712 and/or within the CPU 706 during execution thereof by the computing device 700.

The memory 712 and the CPU 706 may also constitute machine-readable media. The term “machine-readable media”, as used here, refers to a single medium or multiple media (e.g., a centralized or distributed database, and/or associated caches and servers) that store the one or more sets of instructions 720. The term “machine-readable media”, as used here, also refers to any medium that is capable of storing, encoding, or carrying a set of instructions 720 for execution by the computing device 700 and that cause the computing device 700 to perform any one or more of the methodologies of the present disclosure. According to various embodiments, one or more computer applications 724 may be stored on the memory 712.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A smart automotive seat, comprising:
a heating component;
a temperature sensor configured to measure one or more temperature inputs; and
an electronic control unit, comprising a processor and a memory,
wherein the memory is configured to store instructions that, when executed by the processor, are configured to cause the processor to:
read and store, in the memory, the one or more temperature inputs from the temperature sensor;
read and store, in the memory, one or more time inputs;
calculate an Accumulated Exposure Area (AEA) based on the one or more temperature inputs and the one or more time inputs,
wherein:
the AEA is an accumulated area under a temperature time curve and above a Critical Temperature Threshold Value (CTTV), and
the CTTV is a predetermined temperature value representing little to no risk of thermal injury;
determine whether the AEA is greater than a Target Temperature Exposure Area Limit (TEAL),
wherein the TEAL is a predetermined exposure area limit for a current heat level of the heating component; and
when the AEA is greater than the TEAL, reduce the current heat level of the heating component.

2. The smart automotive seat of claim 1, wherein the instructions, when executed by the processor, are further configured to cause the processor to calculate a current AEA.

3. The smart automotive seat of claim 2, wherein calculating the current AEA comprises:
calculating a current seat Heater Sensor Temperature (HST);
determining whether the HST is greater than the CTTV;
when the HST is greater than the CTTV, calculating a Sensor Time Interval (STI) by determining a time interval since a last temperature sensor reading;
calculating a Critical Sensor Temperature (CST) by determining a temperature difference between the HST and the CTTV; and
calculating a Sensor Exposure Area (SEA) by determining a product of the CST and the STI.

4. The smart automotive seat of claim 3, wherein the current AEA equals a sum of the SEA and a previous AEA.

5. The smart automotive seat of claim 1, wherein the instructions, when executed by the processor, are further configured to cause the processor to determine whether a user has changed the current heat level of the heating component.

6. The smart automotive seat of claim 1, wherein the instructions, when executed by the processor, are further configured to cause the processor to, after reducing the current heat level of the heating component, determine whether the heating component is off.

7. The smart automotive seat of claim 1, wherein the electronic control unit comprising a computing device of a vehicle.

8. A system for performing smart seat heater operation, comprising:
a vehicle comprising one or more smart automotive seats, wherein each smart automotive seat comprises:
a heating component;
a temperature sensor configured to measure one or more temperature inputs; and
an electronic control unit, comprising a processor and a memory,
wherein the memory is configured to store instructions that, when executed by the processor, are configured to cause the processor to:
read and store, in the memory, the one or more temperature inputs from the temperature sensor;
read and store, in the memory, one or more time inputs;
calculate an Accumulated Exposure Area (AEA) based on the one or more temperature inputs and the one or more time inputs,
wherein:
the AEA is an accumulated area under a temperature time curve and above a Critical Temperature Threshold Value (CTTV), and
the CTTV is a predetermined temperature value representing little to no risk of thermal injury;
determine whether the AEA is greater than a Target Temperature Exposure Area Limit (TEAL),
wherein the TEAL is a predetermined exposure area limit for a current heat level of the heating component; and
when the AEA is greater than the TEAL, reduce the current heat level of the heating component.

9. The system of claim 8, wherein the instructions, when executed by the processor, are further configured to cause the processor to calculate a current AEA.

10. The system of claim 9, wherein calculating the current AEA comprises:
calculating a current seat Heater Sensor Temperature (HST);
determining whether the HST is greater than the CTTV;
when the HST is greater than the CTTV, calculating a Sensor Time Interval (STI) by determining a time interval since a last temperature sensor reading;
calculating a Critical Sensor Temperature (CST) by determining a temperature difference between the HST and the CTTV; and
calculating a Sensor Exposure Area (SEA) by determining a product of the CST and the STI.

11. The system of claim 10, wherein the current AEA equals a sum of the SEA and a previous AEA.

12. The system of claim 8, wherein the instructions, when executed by the processor, are further configured to cause the processor to determine whether a user has changed the current heat level of the heating component.

13. The system of claim 8, wherein the instructions, when executed by the processor, are further configured to cause the processor to, after reducing the current heat level of the heating component, determine whether the heating component is off.

14. The system of claim 8, wherein the electronic control unit comprising a computing device of the vehicle.

15. A method for performing smart seat heater operation, comprising:
measuring, using a temperature sensor of a smart automotive seat, one or more temperature inputs, wherein the smart automotive seat comprises:
a heating component;
the temperature sensor; and
an electronic control unit, comprising a processor and a memory; and using the electronic control unit;
reading and storing, in the memory, the one or more temperature inputs from the temperature sensor;
reading and storing, in the memory, one or more time inputs;
calculating an Accumulated Exposure Area (AEA) based on the one or more temperature inputs and the one or more time inputs,
wherein:
the AEA is an accumulated area under a temperature time curve and above a Critical Temperature Threshold Value (CTTV), and
the CTTV is a predetermined temperature value representing little to no risk of thermal injury;
determining whether the AEA is greater than a Target Temperature Exposure Area Limit (TEAL),
wherein the TEAL is a predetermined exposure area limit for a current heat level of the heating component; and
when the AEA is greater than the TEAL, reducing the current heat level of the heating component.

16. The method of claim 15, further comprising calculating a current AEA.

17. The method of claim 16, wherein the calculating the current AEA comprises:
calculating a current seat Heater Sensor Temperature (HST);
determining whether the HST is greater than the CTTV;
when the HST is greater than the CTTV, calculating a Sensor Time Interval (STI) by determining a time interval since a last temperature sensor reading;
calculating a Critical Sensor Temperature (CST) by determining a temperature difference between the HST and the CTTV; and
calculating a Sensor Exposure Area (SEA) by determining a product of the CST and the STI.

18. The method of claim 17, wherein the current AEA equals a sum of the SEA and a previous AEA.

19. The method of claim 15, further comprising determining whether a user has changed the current heat level of the heating component.

20. The method of claim 15, further comprising, after reducing the current heat level of the heating component, determining whether the heating component is off.
